(19) United States
(12) Patent Application Publication
(10) Pub. No.: US 2016/0049060 A1
(43) Pub. Date: Feb. 18, 2016

(54) ALARM AGAINST LITTLE INFANTS CARELESSNESS

(71) Applicant: Wilson Gerardo BERNES, Orlando, FL (US)

(72) Inventor: Wilson Gerardo BERNES, Orlando, FL (US)

(21) Appl. No.: 14/824,120

(22) Filed: Aug. 12, 2015

Related U.S. Application Data
(60) Provisional application No. 62/036,151, filed on Aug. 12, 2014.

(51) Int. Cl. G08B 21/02

(52) U.S. Cl. CPC G08B 21/02

(57) ABSTRACT

An alarm against carelessness to young infants, especially babies, installed in the inside of a lighter on a vehicle. Optionally, it can be connected to any point of constant power supply of the vehicle, or with a line directly to the battery. The alarm is armed when the harness or seatbelt is secured, the alarm is activated when the driver opens the door of the vehicle to descend. The alarm alerts the driver via an audible sound buzz about the presence of the little infant inside the vehicle preventing it being locked by mistake.

### CROSS-REFERENCE TO RELATED APPLICATIONS

This application claims the benefit of priority to U.S. Provisional Application No. 62/036,151, filed Aug. 12, 2014, the contents of which are incorporated herein by reference.

### FIELD OF THE INVENTION

The present invention relates to the technical field of car alarms.

### BACKGROUND OF THE INVENTION

There are known, for example, the volumetric car alarms that prevent the robbery of objects that are left in the car or robbery of the car itself. These alarms work by air volume because their sensors take the interior volume of the vehicle when the doors close. In the case of opening a door, when the air enters, the volume changes, triggering the alarm. In the same way, when closing the doors, the windows are not properly closed, a slight breeze changes the internal volume of the car and causes the triggering of the alarm.

Another type of alarm uses the PIR detector (Passive Infrared) or Passive Infrared. This type of detector reacts only to certain energy sources such as human body heat or the animal bodies. Basically, the detectors receive infrared radiation variation of the environmental present in the sector that covers the alarm. This detector is called passive because it does not emit radiations, but the detector receives them. These detectors pick up the presence by detecting the difference between the heat emitted by the human or animal body and the space around it. Its main component is the piezoelectric sensor. It is an electronic component designed to detect changes in the infrared radiation received. Generally, within its encapsulation incorporates a field effect transistor which amplifies the electric signal that is generated when the variation of radiation received occurs. The infrared information reaches the piezoelectric sensor through a Fressnell lens that divides the protected area into sectors. They are lenses with different features: wide angle, curtain, corridor, antimascotas, etc.

Neither of the volumetric alarm or the PIR are suitable to alert about the presence of a small child, especially a baby, inside the car.

There is a need for alarms that prevent that small infants be trapped in the car by the carelessness of the driver. Indeed, the modern life imposes a rhythm of work and outside work activities that demand a strong commitment to remember the proper time for its execution. The fact that there are several family members who work outside the home, requires that the infants be transferred to daycares, kindergartens, schools, workplaces, or other activities in various transportation means. Unfortunately, it has been found on many occasions that infants are forgotten inside the transportation means, since the adults leave them there by mistake or oversight, to go to their work places or other activities. Upon their return, the adults often have found the infants with dehydration, respiratory problems, hypothermia, and in the worst cases even dead. Also, exists the risk of being kidnapped or injured while attempting to free themselves from their harness or security belts of their seats.

### BRIEF SUMMARY OF THE INVENTION

The alarm against carelessness to young infants is a device to alert car drivers of the presence of a small child, especially babies, inside the car. This alarm is intended to prevent situations such as

dehydration, hypothermia, long hours without food, suffocation, and even the death of young infants, who are locked in the car by mistake or negligence of the drivers.

### BRIEF DESCRIPTION OF THE DRAWINGS

FIG. 1 shows a perspective front view of the alarm against carelessness to little infants according to an embodiment of the present invention;

FIG. 2 shows a top view of the central module of FIG. 1;

FIG. 3 shows a side view of the central module of FIG. 2;

FIG. 4 shows a back view of the central module of FIG. 2;

FIG. 5 shows a top view of the printed circuit board including the components installed on the board;

FIG. 6 shows a side view of the circuit board of FIG. 5;

FIG. 7 shows a bottom view of the circuit board of FIG. 5;

FIG. 8 shows the welding of the circuit board of FIG. 5;

FIG. 9 shows the components of the printed circuit board having them already installed;

FIG. 10 shows the component of the printed circuit board indicating where to install the components; and

FIG. 11 shows an example of the installation of the alarm against carelessness to little infants according to an embodiment of the present invention showing where to place the sensors and central module inside the car.

### DETAILED DESCRIPTION OF THE INVENTION

The alarm includes: a first sensor that can be installed in the harness or seatbelt of the chair that supports the small infant in the transportation means; a second sensor that can be installed in the frame or baseboard of the driver's door: a central module comprising: an enclosure containing

a card that plugs into the cigarette lighter outlet of the vehicle, and a printed circuit board that contains the electronic elements.

The sensor located on the frame of the front driver's door closes the circuit when the door is opened by activating an audible alarm located in the central module, which alerts the driver. The central module includes two LED lights, one of the lights indicates that the device is under pressure and the other light indicates that the alarm is activated.

The sensors and the central module are connected together by an electrical conductor cable.

A relay feeds the audible alarm receiving the signal from the sensors. The relay is welded to the printed circuit board of the central module.

When the alarm is plugged into the cigarette lighter outlet of the vehicle, the alarm is activated, one of the LED lights is lighted, which notifies the user that the device is under tension. When the harness or the seat belt of the little infant is closed, the alarm is activated and the second LED light is lighted indicating that the alarm is activated.

When the driver opens the car door to go leave the car, the alarm is activated producing an audible noise (small buzz) alerting that the infant is inside the vehicle. The audible noise only stops once the infant is released from the harness or seatbelt.

### BEST WAY TO MAKE IT IN RELATION TO THE DRAWINGS

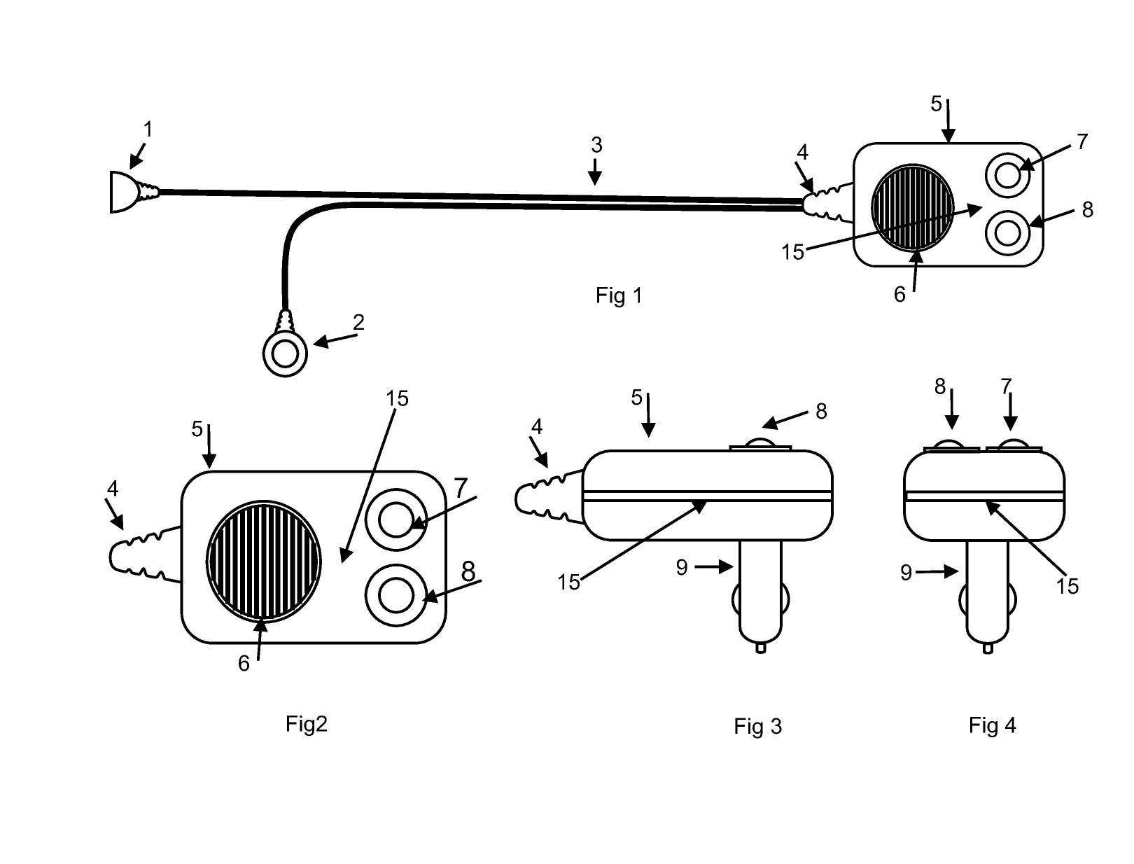

FIG. 1 illustrates a full alarm that includes a sensor for the seatbelt of the small child's chair (1), the sensor of the driver's door (2), a conductor cable (3), a mechanical protection element of the output wires of the central module (4), a central module (15), which elements are within a protective housing (5), openings that allow the passage of the sound of the audible alarm (6), indicator light for the activation of the alarm (7), tension indicator light (8). The sensor of the seatbelt of the small child's chair (1) includes a micro switch that actives when the latch plate attached to the seatbelt is inserted into the coupling thereof. The micro switch is attached to the latch plate by a commonly used element, so activates when the latch plate is inserted. The sensor of the drivers door (2) comprises a micro switch attached by a commonly used element to the baseboard or frame of the vehicle. The micro switches (1 and 2) that act as sensors are micro push switches that can be purchased in electrical material stores. The mechanical protection element of the output of the conductor cables of the central module (4) is a flexible plastic coating like a tube to minimize the mechanical stress cause by the movements of the conductor cable (3). This mechanical protection element of the output of the cables can be purchased in stores selling electrical materials. The central module (15) comprises a printed circuit (12), which is specifically designed for the present device according to the standard procedures used by the skilled in the art, to which electronic elements are welded that will be responsible for the operation of the alarm 1 against carelessness to young infants. The components of the central module mentioned before are contained within a protective housing (5). The protective housing of the elements of the central module (5) is a type of housing which can be acquired in the electrical equipment stores that are used to protect the electrical or electronic parts of modules for different purposes. The activation indicator light (7) is a LED light that can be purchased in electronic material stores. The pressure indicator light (8) is a LED light which can be purchased in electronic material stores. The sensor (1) is connected to the integral elements of the central module (15); a feeding chip (9), responsible for feeding the integrated elements of the central module and is welded to the printed circuit (12); the door sensor (2) is connected to the integral elements of the central module (15); the LED lights (7 and 8) are connected to the printed circuit (12). The feeding chip (9) can be purchased at stores for electrical materials for automotive use; these chips are of the type that is inserted in the current cars cigarette lighter socket for various applications.

FIG. 2 illustrates the mechanical protection element of the output of the conductor cables (4) of the central module (15); the central module (15) which integrate elements are located within the protective housing (5), openings that allow the passage of audible alarm (buzz) (6), the LED light (7) indicator of the alarm activation, a LED light (8) indicator of the pressure. Both LED lights are connected to a printed circuit board (12). The mechanical protection element of the output of the conductor cables (4) are located in the output of the conductor cable (3) of the central module (15).

FIG. 3 illustrates the mechanical protection elements of the output of the conductor cable (4) of the central module (15), the central module (15) whose element members are located within the protective housing (5), the LED light indicator pressure (8) connected to the printed circuit (12), the feeding chip (9) which is installed and welded to the printed circuit (12).

FIG. 4 illustrates the LED light (7) indicator of the activation of the alarm, the LED light (8) indicator of the pressure, both lights are connected to the printed circuit (12), the feeding chip (9) that is installed and welded to the printed circuit (12).

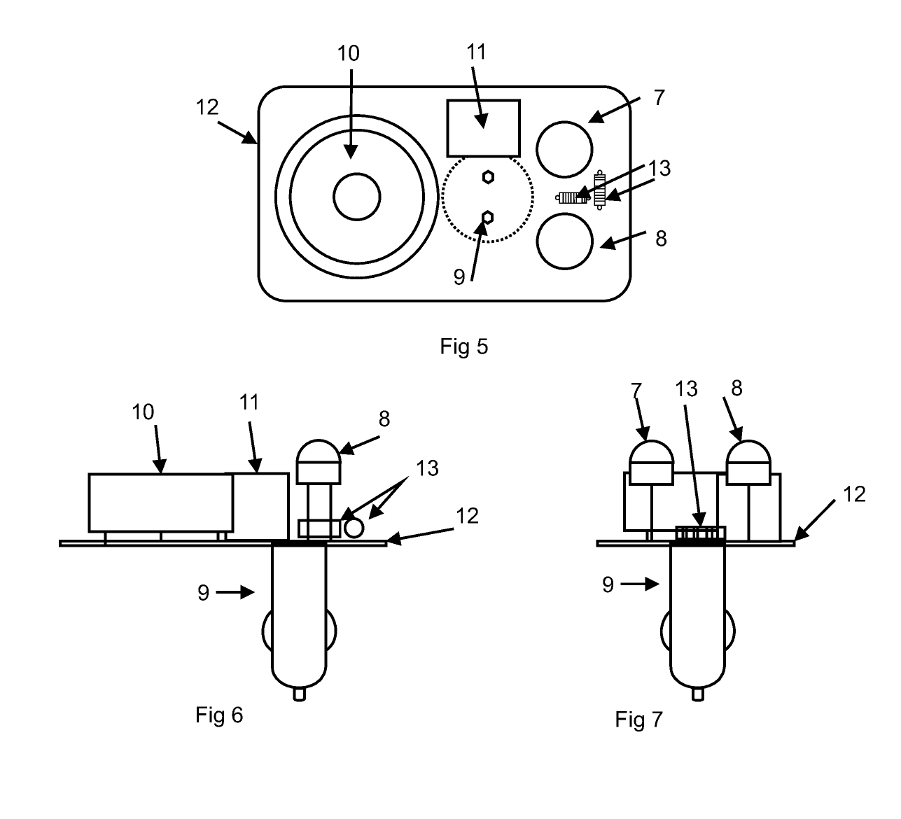

FIG. 5 illustrates a LED light (7) indicator of the activation of the alarm, the LED light (8) indicated of the pressure, both lights are connected to the printed circuit (12), the feeding chip (9) that is installed and welded to the printed circuit (12), the audible alarm (10), the relay (11), the printed circuit board (12), resistances that adjust the tension of the lights (13). The audible alarm (10) can be bought in local electrical material stores. The relay (11) can be purchased in electrical material stores and as well as the resistances (13). The audible alarm is welded in printed circuit board (12) as well as the relay (11), the resistances (13) are also welded to the printed circuit (12). These elements are part of the central module.

FIG. 6 illustrates, from a side view, the components: LED light (8) indicator of pressure, the feeding chip (9), the audible alarm (10), the relay (11), the circuit printed board (12), the resistances that adjusts the tension of the LED lights (13). The LED light (8) indicator of the pressure is connected to the printed circuit board (12). The resistances (13) are soldered to the printed circuit board (12). The feeding chip (9) is installed and welded to the printed circuit board (12). The audible alarm (10) and the relay (11) are also welded to the printed circuit board (12).

FIG. 7 illustrates, from a top view, the components: LED Light (7) indicator of the activation of the alarm, LED light (8) indicator of the pressure, feeding chip (9), the printed circuit board (12), the resistances (13) for adjusting the tension of the LED lights. Both LED lights (7 and 8) are connected to the printed circuit board (12). The resistance (13) is welded to the printed circuit (12), the feeding chip (9) is installed and welded to the printed circuit board (12).

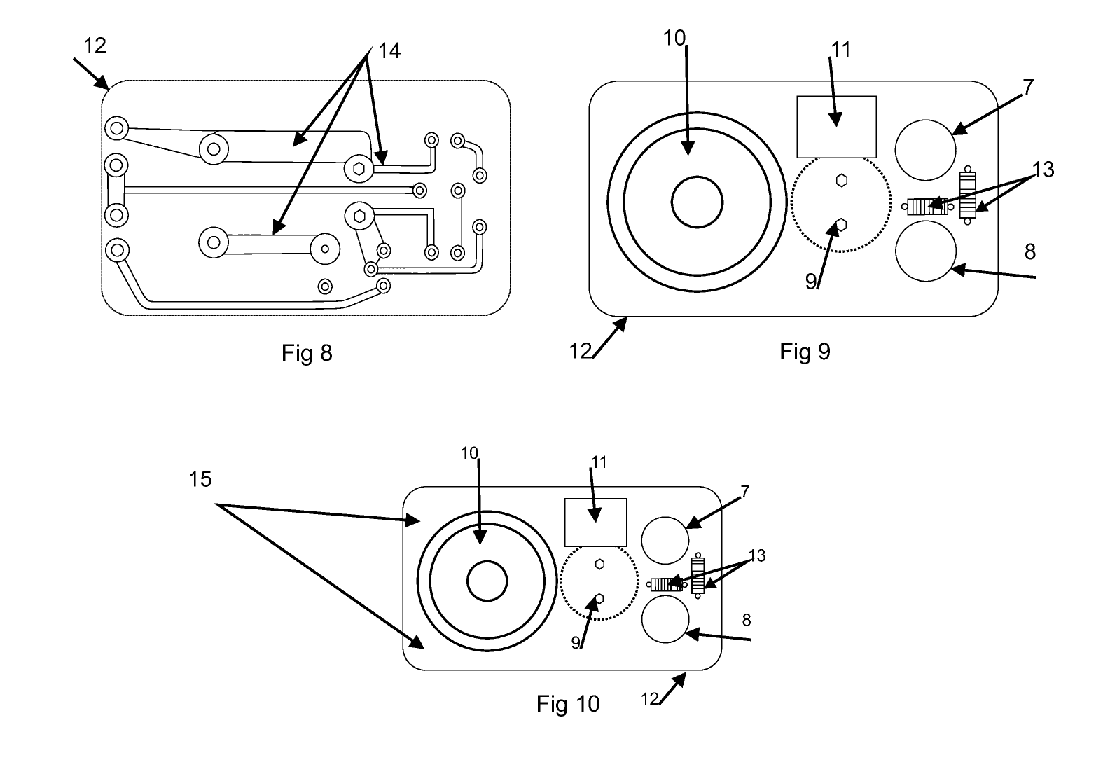

FIG. 8 illustrates the printed circuit board (12) and tracks (14) of the printed circuit. The tracks (14) on the printed circuit board (12) are designed especially for this circuit according to the usual practices for electronic experts in the art.

FIG. 9 illustrates a front view of the LED light (7) indicator of the activation of the alarm, LED light (8) indicator of the pressure; feeding chip (9), the audible alarm (10), the relay (11), the printed circuit board (12), resistance (13) for adjusting the tension of the lights. The LED light (7) indicator of the activation of the alarm (7) and the LED light (8) indicator of the pressure are connected to the printed circuit board (12). The resistance (13) is soldered to the printed circuit board (12). The feeding chip tab (9) is installed and welded to the printed circuit board (12). The audible alarm (10) and the relay (11) are also welded to the printed circuit board (12).

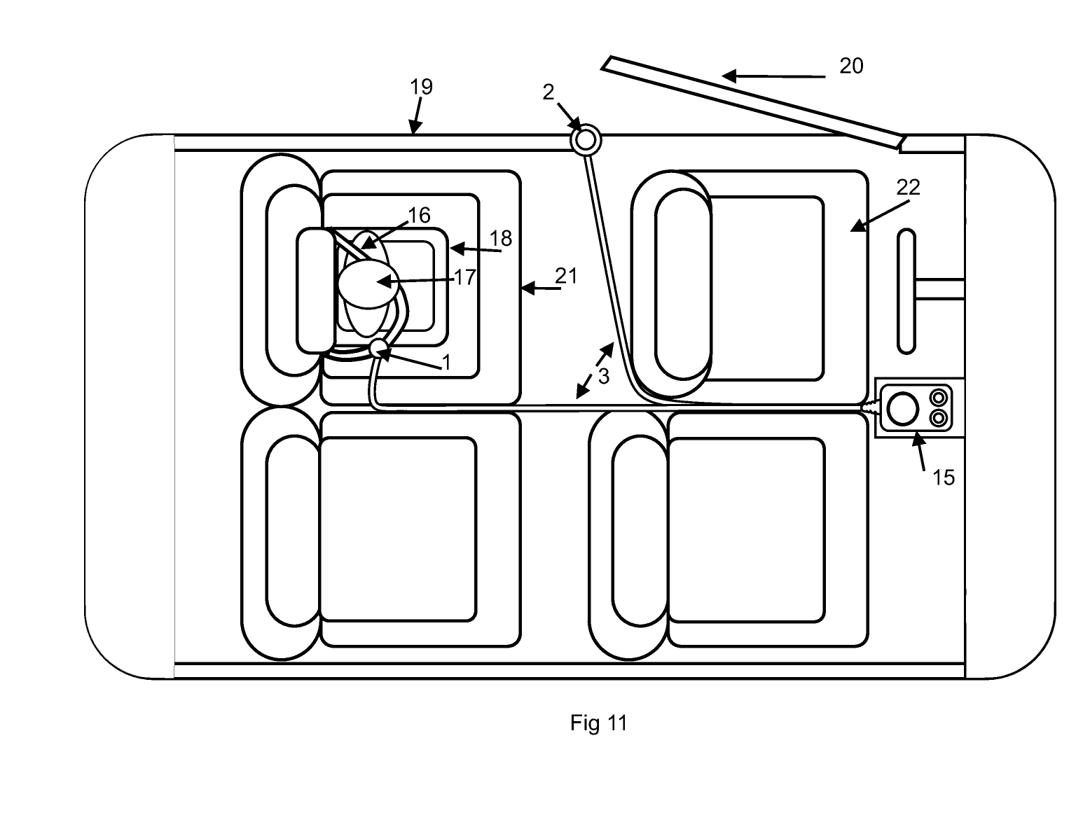

FIG. 10 illustrates the printed circuit board (12) and the central module (15). In the central module (15) are installed all electronic elements.

FIG. 11 illustrates an example of the installation of the device seen in a vehicle where it can be seen the location of the sensor of the seatbelt in the infant chair (1), the sensor of the driver's door (2), the conductor cables (3), the central module (15), the security belt of the infant seat (16), the infant sitting in the chair (17), the infant's chair (18), the vehicle (19), the driver's door (20), rear seat where the seat for the infant is placed (21), a front driver' seat (22).

### Operation

In the harness of the small infant seat or seatbelt, a sensor is installed which includes a switch that when the seatbelt is locked in place, closes a circuit in the alarm. A sensor comprising a switch located on the car door opens or closes (depending on the open or closed state of the door) a circuit, at the appropriate time, actives the audible alarm producing an alert signal. The feeding of the entire circuit is performed through the current car's cigarette lighter socket.

In the case that the vehicle does not have a continuous supply in the outlet, the lighter, the car, the alarm can be powered from any supply of constant electricity which contains the vehicle or through a direct line installed for that purpose to the car battery.

### Use

The small infant is placed in the seat and secured with the harness, or sits on the vehicle seat and secured with a seatbelt. The harness or seatbelt includes a sensor comprising a switch that is part of the alarm for carelessness to little infants, which informs the central unit of the same that the alarm is armed. The driver sits behind the wheel of the vehicle, shuts the door, and inserts the central module of the alarm on current lighter socket. At that time, the alarm is fully armed. Once the vehicle stops, and the driver opens the door to descend, then the alarm produces an audible sound (buzz) alerting the presence of the small child in the vehicle. The audible sound only ceases the noise when the child is removed from the chair or seatbelt.

### INDUSTRIAL APPLICATION

The protective housing of the circuit, which controls and feeds the alarm, can be manufactured by plastic injection in factories or workshops, or optionally of metal sheets in a metallurglc workshop.

The electric circuit protected by the protective housing can be manufactured of Pertinax cooper plating or cooper plating glass fibers, which cooper takes the form of the tracks specially designed

to interconnect the electronic components that form the circuit. The electric circuit can be manufactured in an electronic workshop.

The feeding chip is a standard for car cigarette lighters, available in the market to connect the outlets of the lighter of the vehicles.

The electrical conductor cables may be made of copper wires isolated with PVC, plastic, or rubber which are commercially available.

The relay can be mechanical or of the solid state, both types are available on the market.

It is recommended that the light be LED, as those found in the market.

The components of the central module are found commonly on the market.

1. An alarm against carelessness to young infants characterized by being installed an interior of a vehicle comprising:
a) a central module including a printed circuit board and electronic elements installed to the printed circuit board and a protective housing wherein;
i. the electronic elements include a LED light indicator of the activation of the alarm, a LED light indicator of the pressure, resistances, a relay, an audible alarm, a feeding chip to be connected to a cigarette lighter socket on the vehicle;
ii. the protective housing encasing the printed circuit board and the electronic elements.
b) a sensor adapted to be placed on a seat harness or seatbelt for a small child, the sensor is connected to the central module by using an electrical conductor; and
c) a sensor adapted to be located on a frame of a driver door on the vehicle, the sensor is connected to the central module by using an electrical conductor.

2. The alarm against carelessness to young infants according to claim 1, wherein the alarm is connected to the vehicle cigarette lighter socket.

3. The alarm against carelessness to young infants according to claim 1, wherein the alarm is connected to a source of constant supply of voltage on the vehicle.

4. The alarm against carelessness to young infants according to claim 1, wherein the alarm is connected by a line directly to a battery of the vehicle.
